(19) United States
(12) Patent Application Publication
(10) Pub. No.: US 2005/0196495 A1
(43) Pub. Date: Sep. 8, 2005

(54) Method for manufacturing snacks

(76) Inventor: Hiroaki Sakaguchi, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/874,191

(22) Filed: Jun. 24, 2004

(30) Foreign Application Priority Data
Mar. 8, 2004 (JP) 2004-63905

(51) Int. Cl. A23L 3/00

(52) U.S. Cl. 426/241

(57) ABSTRACT

[Problem]

To provide a method for manufacturing snacks that can achieve crispy eating sensation similar to that of conventional snacks without deep-frying.

[Means for Solving Problem]

In the present invention, material is molded to generate pellets, and after rolling the generated pellets, the relevant pellets are irradiated with hot air to expand. Furthermore, after seasoning the expanded pellets to the desired flavor, the pellets are baked. Consequently, the present invention can provide a method for manufacturing snacks with crispy eating sensation similar to that of conventional snacks without deep-frying.

### BACKGROUND OF THE INVENTION

1. Field of the Invention

The present invention relates to a method for manufacturing snacks which can be manufactured without adding any oil other than the oil contained in the material itself.

2. Description of Related Art

[Conventional Technology]

As an example of snacks that have been frequently eaten hitherto, a potato chip can be mentioned, which is popularly accepted with its distinctive crunch. This potato chip can be not only handily eaten but also is available at an inexpensive price and is one of the snacks, which are most popularly eaten worldwide.

This kind of potato chip is prepared by thinly slicing potatoes, the material, deep-frying in oil, and seasoning by salts and other flavors.

3. Disclosure of the Invention

[Problem to be Solved by the Invention]

However, snacks manufactured by the above-mentioned conventional method, in particular, the potato chip has a problem that it has inevitably high calorie content because it must undergo the process of deep-frying in oil in order to obtain that crispy eating sensation.

This problem indicates that the same request is leveled at snacks, too, in the recent trends of people's preference for low-calories with the food calorie suppressed to the lowest possible for antiobesity or for prevention of adult diseases.

Therefore, it is assumed to manufacture snacks without deep-frying material in oil, but if snacks are manufactured without deep-frying, it becomes difficult to obtain the crispy eating sensation and there is a problem that the attractive quality original to snacks cannot be obtained.

The present invention is made to solve the above-mentioned problem and it is the first object of the present invention to provide a method for manufacturing snacks that can achieve crispy eating sensation similar to that of conventional snacks without deep-frying.

In addition, it is the second object of the present invention to provide a method for manufacturing snacks which have low calorie with the use of oil suppressed but with the tastes not impaired, and at the same time, snacks which are suited for prevention of obesity and adult diseases.

### SUMMARY OF THE INVENTION

In order to solve the above-mentioned problem, a method for manufacturing snacks related to the present invention is characterized in that the method comprises a molding process for molding the material into a desired thickness, a desired size, and a desired shape, and a process for hot air irradiating process for irradiating and expanding the material molded by the molding process with hot air.

In addition, it is characterized in that the hot air irradiating process irradiates the material placed on a specified conveying means with hot air.

In addition, it is characterized in that the molding process provides rolling treatment after processing the material into a form of pellets.

In addition, it is characterized in that the molding process carries out punching to process the material into a sheet form (plate form) and adjusts to a desired thickness and converts the sheet-form material into a desired size and a desired shape.

In addition, it is characterized in that the hot air is irradiated from a plurality of nozzles.

In addition, it is characterized in that the plurality of nozzles are arranged in such a manner that the nozzles can irradiate the top surface of the specified conveying means or the top surface and the bottom surface of the specified conveying means with the hot air.

In addition, it is characterized in that the material has the moisture content adjusted in advance by drying by the use of far infrared rays or electromagnetic waves after steaming or boiling.

In addition, it is characterized in that it further comprises a flavoring process for seasoning the material irradiated with hot air by the hot air irradiating process with the desired flavors, and a baking process for baking the material seasoned to provide the specified flavor by the flavoring process as the subsequent processes of the hot air irradiation process.

In addition, it is characterized in that the flavoring process seasons the material irradiated with the hot air by atomizing seasonings.

Furthermore, it is characterized in that the material is generated by kneading after pulverizing any of vegetables, root vegetables, fish and seafood or butchers' meat or combinations of these.

### EFFECT OF THE INVENTION

According to the present invention, because the material containing the desired volume of moisture is expanded by irradiating with hot air after it is molded into the specified thickness, specified size, and specified shape, it is possible to manufacture snacks that does not contain any additional oil other than that originally contained in the material itself and that provides crispy eating sensation and to provide snacks which have less calories and fats and are effectives for preventing obesity and adult diseases.

In addition, according to the present invention, it is possible to provide a method for manufacturing snacks which are easy to manufacture and are low in cost suited for commercial production.

Furthermore, according to the present invention, because the seasoned pellets are finished by the use of a baking method by infrared rays or electromagnetic waves, the whole pellets can be dried uniformly and in a short time and the crispy eating sensation can be obtained uniformly in all without losing any of its distinctive crunchiness.

### BRIEF DESCRIPTION OF THE DRAWINGS

FIG. 1 is a flow chart indicating a method for manufacturing snacks according to the first embodiment of the present invention;

FIG. 2 is a flow chart indicating a method for manufacturing snacks according to the second embodiment of the present invention;

FIG. 3 is a conceptual drawing that indicates the first method of the hot air irradiation process; and

FIG. 4 is a conceptual drawing that indicates the second method of the hot air irradiation process.

### DESCRIPTION OF THE EMBODIMENTS

Referring now to the attached drawings, methods for manufacturing snacks which are working examples of the present invention will be described in detail as follows.

### EXAMPLE 1

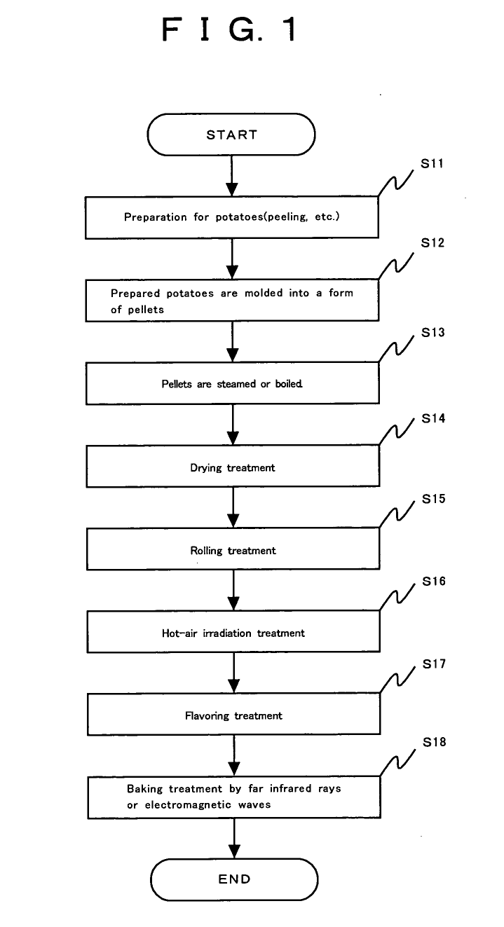

FIG. 1 is a flow chart that indicates a manufacturing process of snacks according to the first working example. First of all, potatoes are used for the material and peeled for preparation (Step S11).

By the way, in the present invention, potatoes are used for material but the present invention shall not always be limited to potatoes but any other tubers and roots may be used, and in addition, not only tubers and roots but also various foodstuff such as other culinary plants, fruits, fish and seafood, and butchers' meats can be used for material.

Furthermore, it is possible to crush and pulverize culinary vegetables, root vegetables, fish and seafood, butchers' meat, and others, add wheat flour, rice flour, starches, etc. as secondary material to them, and knead them to use for material. In such event, the secondary material is not always necessary to be added, but by adding this secondary material, it is possible to improve thickening of material.

Then, the potatoes prepared in Step S11 are molded into the form of pellets (Step S12). Pelletizing referred to here means a treatment for cutting material potatoes and shredding them into small pieces that measure 1 to 2 cm square. Specifically, after peeling potatoes, the peeled potatoes are sliced into a specified size and thickness (for example, the size is 2 cm² and thickness is about 4 mm) and are molded into a form of pellets.

By the way, potatoes are not necessarily made into pellets but in the event that the material itself is of small pieces (thin lumps), the relevant material may be used as it is.

Then, after steaming or boiling each pellet thinly cut in Step S12 (Step S13), a drying process takes place so that each pellet achieves a desired moisture content (Step S14).

The drying treatment in Step S14 is to carry out the drying treatment by the use of infrared rays or electromagnetic waves so that the pellet moisture content becomes 5-20%, and the pellets can be dried not only in a short time but also homogeneously from the pellet center portion to the end portion. By using this drying method, the crunchiness can be obtained uniformly throughout the whole pellets.

Then, each pellet which is dried to have uniform moisture content in Step S14 is rolled by a roller press for rolling (Step S15).

The pellet rolled in Step S15 is transferred to a hot-air irradiation process by a conveying means such as a belt conveyor, etc. and is irradiated with hot air (Step S16). Hot-air irradiation in this step is carried out by high-temperature hot air irradiated from a plurality of nozzles and is carried out to expand each pellet conveyed. The detail of the hot-air irradiation process will be later described.

The pellet irradiated with hot air in Step S16 has the moisture content on the relevant pellet surface dried and at the same time, the moisture contained in the pellet inside (the fibers and cells when a potato is used for the material) is vaporized to become steam and is swollen (expanded) by the pressure which escapes to the outside (pellet surface direction). In such event, in the pellet inside, a large amount of fibers and cell membranes expanded by the steam remain as air bubbles. By these air bubbles, the original form of snacks equipped with crispy eating sensation can be obtained.

Next, seasonings such as salt, glutamic acid, various extracts (for example, beef extract), and others are sprayed by a non-oil spray to the pellet expanded in Step S16 (hereinafter called the “snacks”) for flavoring (Step S17). In this step, flavoring treatment is carried out by atomizing the polysaccharide thickening agent over the surface of expanded pellet, but preferably by the use of a rotary tumbler, the treatment is carried out by constantly rotating the atomizing means so that the seasonings are homogeneously atomized over each pellet.

By the way, by the use of a non-oil spray, it is possible to manufacture snacks with the oil content contained in the material itself, but if milder flavor is preferred, flavoring treatment by the use of a spray with a small amount of oil added may be carried out.

In addition, snacks which have completed the flavoring treatment may be allowed to infiltrate the seasonings atomized over the individual snack surfaces by temporarily cooling at room temperature before baking takes place.

The snacks obtained as described above are baked by the use of infrared rays or electromagnetic waves again (Step S18). By the way, this baking treatment is carried out to remove excess remaining moisture content and to achieve 2-10% moisture content. By baking the snacks uniformly from the surface to the inside by this treatment, it is possible to manufacture snacks with still more crispy eating sensation, savoriness, and spiciness.

The snacks manufactured as described above go through a screening process (picking process) for equalizing the size and shape variations and are weighed into a volume delivered and packaged into one packing pouch by a weighing process. The snacks divided into weighed volume are delivered into packing pouches, then, packed into carton boxes, and distributed to the market.

### EXAMPLE 2

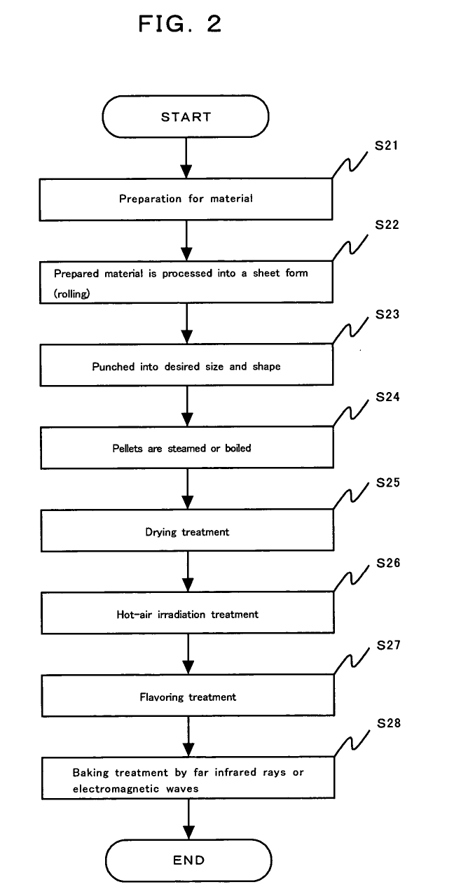

FIG. 2 is a flow chart that indicates a process for manufacturing snacks according to Working Example 2 of the present invention. First of all, as raw material, culinary vegetables, root vegetables, fish and seafood, butchers' meat, and others are crushed and pulverized, and then, wheat flour, rice flour, starches, etc. are added as the secondary material and kneaded together to prepare the material (Step S21).

Then, after molding (rolling) the material prepared in Step S21 into a sheet of a desired thickness by the use of roller press, etc. (Step S22), the sheet is punched into desired shapes, and the material is formed into pellets (Step S23). The pellet referred to here means a material formed into a small piece that measures, for example, 1 to 2 cm square by about 4 mm thick.

Then, after steaming or boiling each pellet thinly cut in Step S2 (Step S24), a drying process takes place so that each pellet achieves a desired moisture content (Step S25).

The drying treatment in Step S25 is to carry out the drying treatment by the use of infrared rays or electromagnetic waves so that the pellet moisture content becomes 5-20% as is the case of working example 1, and the pellets can be dried not only in a short time but also homogeneously from the pellet center portion to the end portion. By using this drying method, the crunchiness can be obtained uniformly throughout the whole pellets.

Then, each pellet which is dried to have uniform moisture content in Step 25 is transferred to a hot-air irradiation process by a conveying means such as a belt conveyor, etc. and is irradiated with hot air (Step S26). Hot-air irradiation in this step is carried out by high-temperature hot air irradiated from a plurality of nozzles and is carried out to expand each pellet conveyed. The detail of the hot-air irradiation process will be later described.

The pellet irradiated with hot air in Step S26 has the moisture content on the relevant pellet surface dried and at the same time, the moisture contained in the pellet inside (the fibers and cells when a potato is used for the material) is vaporized to become steam and is swollen (expanded) by the pressure which escapes to the outside (pellet surface direction). In such event, in the pellet inside, a large amount of fibers and cell membranes expanded by the steam remain as air bubbles. By these air bubbles, the original form of snacks equipped with crispy eating sensation can be obtained.

Next, after seasonings such as salt, glutamic acid, various extracts (for example, beef extract), and others are sprayed by a non-oil spray to the pellet expanded (hereinafter called the “snacks”) for flavoring (Step S27) same as working example 1, the snacks are baked by the use of infrared rays or electromagnetic waves again (Step S28).

The snacks manufactured as described above go through a screening process (picking process) for equalizing the size and shape variations and are weighed into a volume delivered and packaged into one packing pouch by a weighing process. The snacks divided into weighed volume are delivered into packing pouches, then, packed into carton boxes, and distributed to the market.

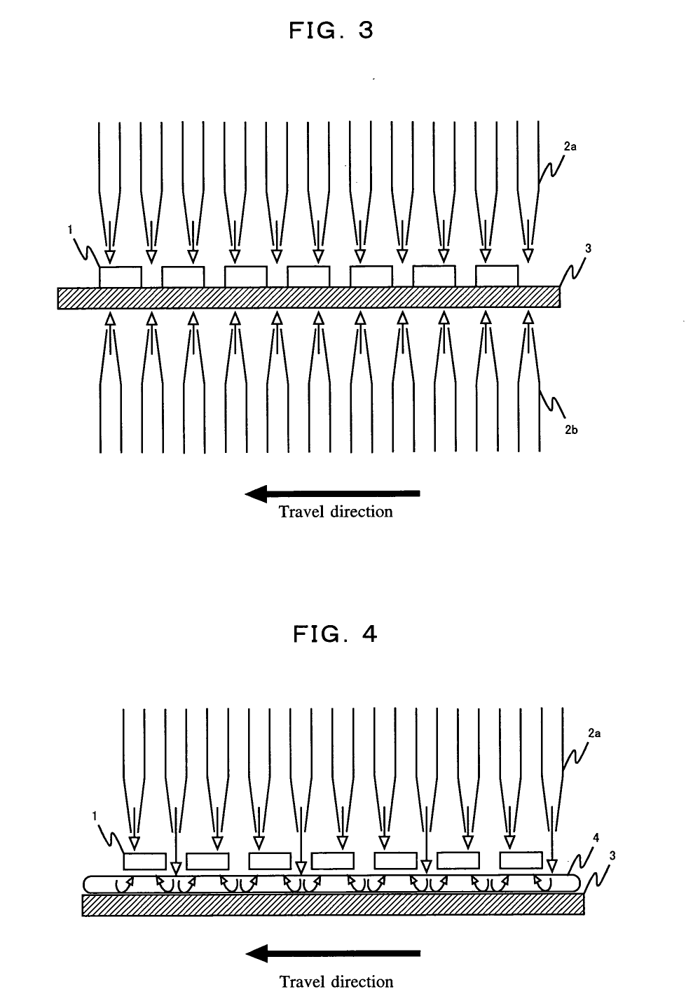

Referring now to FIG. 3 and FIG. 4, the hot air irradiation process will be described in detail. By the way, in each of the first and the second embodiments, the hot air irradiation method shown below may be adopted.

In FIG. 3, as the first method of the hot air irradiation process, hot air irradiation nozzles 2a, 2b are installed in the top and bottom directions, respectively, with respect to pellet 1 placed on a belt conveyor 3. For a mechanism for applying this hot air, a plurality of hot air irradiation nozzles are arranged in such a manner that one set of the plurality of hot air irradiation nozzles sprays hot air over the top surface of the relevant belt conveyor 3 for the rolled pellet 1 placed and successively conveyed on the belt conveyor 3 and at the same time the other set of the plurality of hot air irradiation nozzles spray hot air to the bottom surface of the belt conveyor 3. The temperature of hot air irradiated from these hot air irradiation nozzles is adjustable in the range from 80 to 350° C. In addition, the irradiation rate can be adjusted in the range from 5 m to 70 m per second.

By the way, needless to say, the hot air temperature and irradiation rate can have their settings varied suitably by the operator in accord with the pellet material, size, etc.

In FIG. 4, as the second method of the hot air irradiation process, hot-air irradiation nozzles 2a for irradiating hot air from the top direction only are installed. For a mechanism for applying this hot air, a plurality of hot air irradiation nozzles are arranged in such a manner that the plurality of hot air irradiation nozzles sprays hot air over the top surface of the relevant belt conveyor 3 for the rolled pellet 1 placed and successively conveyed on the belt conveyor 3. Because the hot air irradiated from the hot air irradiation nozzle 2a forms an air bed layer 4 on the belt conveyor 3, pellet 1 is expanded by the hot air irradiated from the hot air irradiation nozzles 2a installed to the top while it is being conveyed successively on the relevant air bed layer 4. Same as in the case of the first method, the temperature of hot air irradiated from these hot air irradiation nozzles is adjustable in the range from 80 to 350° C., and the irradiation rate can be adjusted in the range from 5 m to 70 m per second.

By the way, each working example described above is a preferred embodiment of the present invention and can be practiced by making various changes and modifications without departing from the spirit and scope thereof.

1. A method for manufacturing snacks comprising:
a molding process for molding the material into a desired thickness, a desired size, and a desired shape, and
a process for hot air irradiating process for irradiating and expanding the material molded by the molding process with hot air.

2. The method for manufacturing snacks according to claim 1 wherein the hot air irradiating process irradiates the material placed on a specified conveying means with hot air.

3. The method for manufacturing snacks according to claim 1 wherein the molding process provides rolling treatment after processing the material into a form of pellets.

4. The method for manufacturing snacks according to claim 1 wherein the molding process carries out punching to process the material into a sheet form (plate form) and adjusts to a desired thickness and converts the sheet-form material into a desired size and a desired shape.

5. The method for manufacturing snacks according to claim 1 wherein the hot air is irradiated from a plurality of nozzles.

6. The method for manufacturing snacks according to claim 5 wherein the plurality of nozzles are arranged in such a manner that the nozzles can irradiate the top surface of the specified conveying means or the top surface and the bottom surface of the specified conveying means with the hot air.

7. The method for manufacturing snacks according to claim 1 wherein the material has the moisture content adjusted in advance by drying by the use of far infrared rays or electromagnetic waves after steaming or boiling.

8. The method for manufacturing snacks according to claim 1 further comprising:
a flavoring process for seasoning the material irradiated with hot air by the hot air irradiating process with the desired flavors, and
a baking process for baking the material seasoned to provide the specified flavor by the flavoring process as the subsequent processes of the hot air irradiation process.

9. The method for manufacturing snacks according to claim 8 wherein the flavoring process seasons the material irradiated with the hot air by atomizing seasonings.

10. The method for manufacturing snacks according to claim 1 wherein the material is generated by kneading after pulverizing any of vegetables, root vegetables, fish and seafood or butchers' meat or combinations of these.
